(19) United States
(12) Patent Application Publication
(10) Pub. No.: US 2021/0182387 A1
(43) Pub. Date: Jun. 17, 2021

(54) Automated semantic modeling of system events

(71) Applicant: International Business Machines Corporation, Armonk, NY (US)

(72) Inventors: Ziyun Zhu, Jersey City, NJ (US); Xiaokui Shu, Ossining, NY (US); Dhilung Hang Kirat, White Plains, NY (US); Jiyong Jang, White Plains, NY (US); Marc Philippe Stoecklin, White Plains, NY (US)

(73) Assignee: International Business Machines Corporation, Armonk, NY (US)

(21) Appl. No.: 16/711,688

(22) Filed: Dec. 12, 2019

(51) Int. Cl. G06F 21/55; G06F 21/52; G06N 7/00; G06N 20/00; G06K 9/62

(52) U.S. Cl. CPC G06F 21/554; G06F 21/52; G06K 9/6215; G06N 20/00; G06K 9/6232; G06N 7/005

(57) ABSTRACT

A method to detect anomalous behavior in an execution environment. A set of system events captured from a monitored computing system are received. Using the received system events, a model is then trained using machine learning. The model is trained to automatically extract one or more features for the received set of system events, wherein a system event feature is determined by a semantic analysis and represents a semantic relationship between or among a grouping of system events that are observed to co-occur in an observation sample. An observation sample is associated with an operating scenario that has occurred in the execution environment. Once trained, and using the features, the model is used to detect anomalous behavior. As an optimization, prior to training, the set of system events are pre-processed into a reduced set of system events. The modeler may comprise a component of a malware detection system.

### STATEMENT REGARDING SPONSORED RESEARCH

This invention was made with government support under Contract FA8650-15-C-7561 awarded by the Defense Advanced Research Projects Agency (DARPA). The government has certain rights in the invention.

### BACKGROUND

### Technical Field

This disclosure relates generally to computer network security and, in particular, to behavior-based techniques for characterizing malware.

### Background of the Related Art

Intrusion and anomaly detection products, systems and services are well-known. Indeed, methods for intrusion detection and anti-virus solutions were introduced decades ago. Most traditional host-based and network-based attack/intrusion detection products utilize a static signature matching approach. For example, traditional anti-virus, firewall, intrusion detection systems (IDS), and the like, rely on concrete binary or network communication signatures to identify attacks. The detection procedure typically includes: (i) attack discovery, (ii) signature selection, (iii) signature distribution, and (iv) endpoint signature matching.

A new class of detection mechanisms tries to port more and more intelligence into an endpoint. These mechanisms, however, typically focus on single-process detection. Intra-process behavior modeling and detection also is well-known, as evidenced by program anomaly detection literature, as well as most state-of-the-art commercial endpoint intrusion detection products. These mechanisms basically monitor system events, e.g., system calls and/or Windows APIs of each process, and then decide whether the process is malicious based on its behavior model. A solution of this type can be nullified when stealthy attacks are implemented across processes, or when the attacker leverages benign processes to achieve attack goals.

As a modern computing platform typically acts as a black box, the detailed behaviors of malware or intrusion actions are usually invisible. Thus, and even with sophisticated behavior-based malware detection systems, incomplete observations can greatly limit the ability of detecting attacks, especially advanced persistent threats (APT) that last for a long time period. In particular, commonly-used detection techniques, such as those based on data-flow and control-flow graphs, are not readily observable. Rather, only system call traces can be monitored.

Although the system call is insufficient to understand the detailed behavior of an underlying program, it may reveal the actions and intent of an attacker at a high-level. For example, disk operations can be recorded by API call traces, and writes (e.g., to rundll32.exe) indicates that malicious code is injected in the system file. Excepting disk operations, other behaviors—e.g. communications with remote servers, registry changes, process spawning, and the like—usually are exhibited through system calls, and these behaviors thus are capable of being recorded by a monitoring system. Stated another way, typically it is practical and potentially important to detect attacks at the level of API calls and system events.

Prior art work has shown that system events are effective in modeling malware, particularly in malware classification and evasive malware detection. For example, Mohasisen et al describe using an n-gram of system events as the feature to classify malware families. In the context of big data, however, n-gram modeling without any optimization is not practical. In another approach, Mohasisen et al use a count of system events as the feature; in this approach, however, details from system events are removed, and this is disadvantageous, as the missing details may be very informative. For example, system DLLs are used in different scenarios and cannot be modeled simply as DLL. Bayer et al model a sample as set of system events, and similarity is calculated using Jaccard index. Gionis et al describe using Locality Sensitive Hashing (LSH) to efficiently calculate pairwise similarity, but in this approach every system event is considered as independent and contributes equally to the similarity measurement. Similarly, Lindorfer et al model the sample as a set of system events, and they describe using Jaccard index as the distance metrics. In this latter work, the evasive malware is identified by comparing the system events monitored from different environments. Kirat et al describe comparing the system events by mapping the events to a tree structure, where parent nodes capture important components (like event operations) and child nodes represent less important components (like event names). Then, a similarity metric is determined by the hierarchy. Such a hierarchical structure, however, does not capture the activities underlying the system events. For example, a process loading crypt32.dll is very likely to retrieve a certificate revocation list (CRL) from a remote server. But, any such relationship cannot be captured simply by examining the underlying event operation type and event object name. In Xu et al, redundant system events are removed based on a time pattern. But, this approach cannot determine the relationship of events if there are no temporal dependencies.

Thus, there remains a need to provide behavior-based malware detection systems and methods that can detect malware attacks, preferably by evaluating system events at a level and in a manner that exposes more useful information for the detection process.

### BRIEF SUMMARY

This disclosure describes a method, apparatus and computer program product to detect anomalous behavior in an execution environment. According to the method, a set of system events captured from a monitored computing system are received. Using the received system events, a model is then trained using machine learning. The model is trained to automatically extract one or more features for the received set of system events, wherein a system event feature is determined by a semantic analysis and represents a semantic relationship between or among a grouping of system events that are observed to co-occur in an observation sample. An observation sample typically is associated with an operating scenario that has occurred in the execution environment. Once trained, and using the one or more features, the model is then used to detect anomalous behavior. As an optimization, prior to training, the set of system events are pre-processed using domain knowledge and/or statistical methods into a reduced set of system events. The modeler may comprise a component of a behavior-based malware detection system.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the disclosed subject matter and the advantages thereof, reference is now made to the following descriptions taken in conjunction with the accompanying drawings, in which:

FIG. 1 depicts an exemplary block diagram of a distributed data processing environment in which exemplary aspects of the illustrative embodiments may be implemented;

FIG. 2 is an exemplary block diagram of a data processing system in which exemplary aspects of the illustrative embodiments may be implemented;

FIG. 3 illustrates a security intelligence platform in which the techniques of this disclosure may be practiced;

FIG. 4 depicts an Advanced Persistent Threat (APT) platform in which the techniques of this disclosure may be practiced;

FIG. 5 illustrates an operating environment in which a cognitive cybersecurity intelligence center is used to manage an endpoint machine and in which the techniques of this disclosure may be implemented;

FIG. 6 depicts a malware detection system and a system event modeler of this disclosure;

FIG. 7 depicts an event feature extractor cost function;

FIG. 8 depicts a probability function computed by the event feature extractor; and

FIG. 9 depicts a cosine similarity function used by a semantic prototype extractor of the event modeler of this disclosure.

### DETAILED DESCRIPTION OF AN ILLUSTRATIVE EMBODIMENT

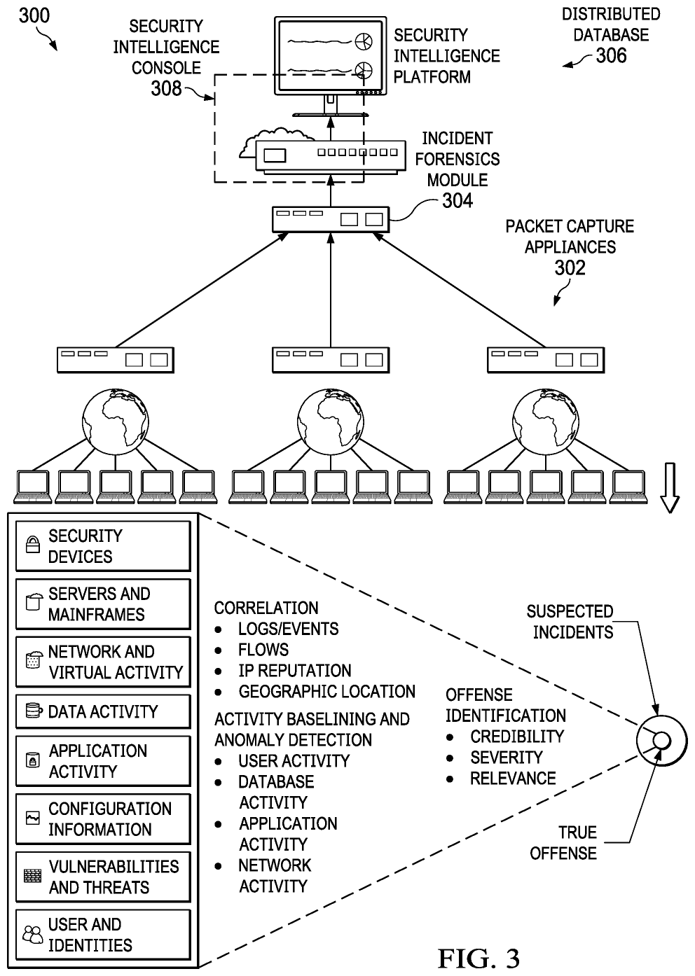

As will be described below, the techniques herein utilize machine learning to derive semantic models of system events for use to provide behavior-based malware detection. Typically, machine learning algorithms and associated mechanisms execute as software, e.g., one or more computer programs, executing in one or more computing machines. As background, the following describes representative computing machines and systems that may be utilized for executing the learning process and using the derived system event model. Several execution environments (FIGS. 3-5) are also described.

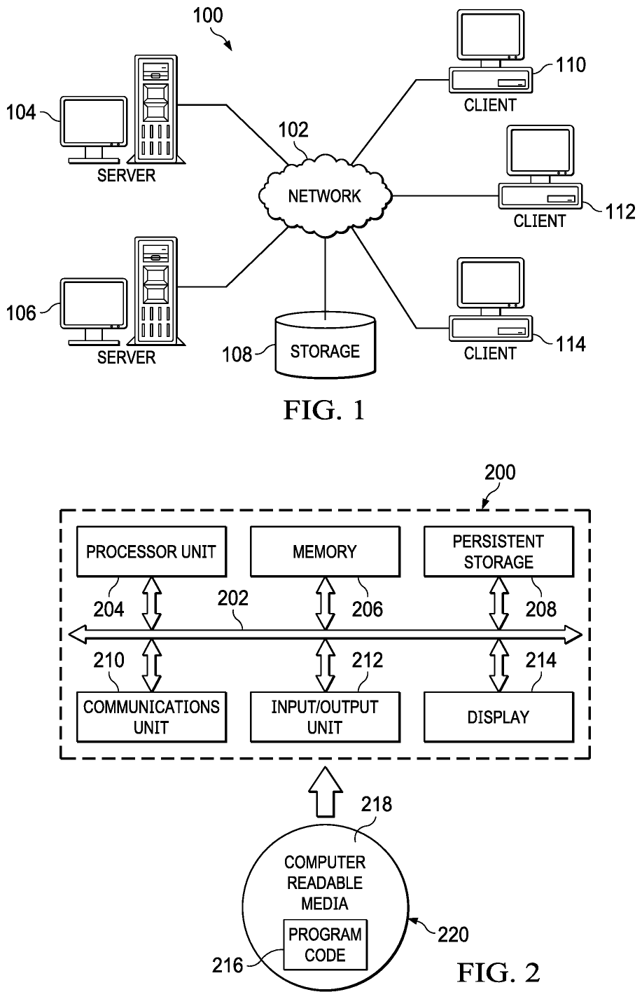

With reference now to the drawings and in particular with reference to FIGS. 1-2, exemplary diagrams of data processing environments are provided in which illustrative embodiments of the disclosure may be implemented. It should be appreciated that FIGS. 1-2 are only exemplary and are not intended to assert or imply any limitation with regard to the environments in which aspects or embodiments of the disclosed subject matter may be implemented. Many modifications to the depicted environments may be made without departing from the spirit and scope of the present invention.

With reference now to the drawings, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the disclosed subject matter, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the disclosure may be located.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor (SMP) system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code. The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Computer program code for carrying out operations of the present invention may be written in any combination of one or more programming languages, including an object-oriented programming language such as Java™, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the disclosed subject matter.

As will be seen, the techniques described herein may operate in conjunction within the standard client-server paradigm such as illustrated in FIG. 1 in which client machines communicate with an Internet-accessible Web-based portal executing on a set of one or more machines. End users operate Internet-connectable devices (e.g., desktop computers, notebook computers, Internet-enabled mobile devices, or the like) that are capable of accessing and interacting with the portal. Typically, each client or server machine is a data processing system such as illustrated in FIG. 2 comprising hardware and software, and these entities communicate with one another over a network, such as the Internet, an intranet, an extranet, a private network, or any other communications medium or link. A data processing system typically includes one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF). Familiarity with these standards is presumed.

Computing machines such as described above may provide for machine learning. As is well-known, machine learning involves using analytic models and algorithms that iteratively learn from data, thus allowing computers to find insights in the data without being explicitly programmed where to look. Machine learning may be supervised or unsupervised. Supervised machine learning involves using training examples by which the machine can learn how to perform a given task. Unsupervised machine learning, in contrast, involves providing unlabeled data objects, which the machine then processes to determine an organization of the data. One well-known type of unsupervised machine learning is clustering, which refers to the notion of assigning a set of observations into subsets, which are referred to as “clusters,” such that observations within a cluster have a degree of similarity. A common approach to clustering is k-means clustering, which is an algorithm that classifies or groups objects based on attributes or features into k number of group, typically by minimizing a sum of squares of distances between data and a centroid of a corresponding cluster. Unsupervised machine learning via clustering provides a way to classify the data. Other clustering algorithms are well-known.

Security Intelligence Platform with Incident Forensics

A representative security intelligence platform in which the techniques of this disclosure may be practiced is illustrated in FIG. 3.

Generally, the platform provides search-driven data exploration, session reconstruction, and forensics intelligence to assist security incident investigations. In pertinent part, the platform 300 comprises a set of packet capture appliances 302, an incident forensics module appliance 304, a distributed database 306, and a security intelligence console 308. The packet capture and module appliances are configured as network appliances, or they may be configured as virtual appliances. The packet capture appliances 302 are operative to capture packets off the network (using known packet capture (pcap) application programming interfaces (APIs) or other known techniques), and to provide such data (e.g., real-time log event and network flow) to the distributed database 306, where the data is stored and available for analysis by the forensics module 304 and the security intelligence console 308. A packet capture appliance operates in a session-oriented manner, capturing all packets in a flow, and indexing metadata and payloads to enable fast search-driven data exploration. The database 306 provides a forensics repository, which distributed and heterogeneous data sets comprising the information collected by the packet capture appliances. The console 308 provides a web- or cloud-accessible user interface (UI) that exposes a “Forensics” dashboard tab to facilitate an incident investigation workflow by an investigator. Using the dashboard, an investigator selects a security incident. The incident forensics module 304 retrieves all the packets (including metadata, payloads, etc.) for a selected security incident and reconstructs the session for analysis. A representative commercial product that implements an incident investigation workflow of this type is IBM® Security QRadar® Incident Forensics V7.2.3 (or higher). Using this platform, an investigator searches across the distributed and heterogeneous data sets stored in the database, and receives a unified search results list. The search results may be merged in a grid, and they can be visualized in a “digital impression” tool so that the user can explore relationships between identities.

Typically, an appliance for use in the above-described system is implemented is implemented as a network-connected, non-display device. For example, appliances built purposely for performing traditional middleware service oriented architecture (SOA) functions are prevalent across certain computer environments. SOA middleware appliances may simplify, help secure or accelerate XML and Web services deployments while extending an existing SOA infrastructure across an enterprise. The utilization of middleware-purposed hardware and a lightweight middleware stack can address the performance burden experienced by conventional software solutions. In addition, the appliance form-factor provides a secure, consumable packaging for implementing middleware SOA functions. One particular advantage that these types of devices provide is to offload processing from back-end systems. A network appliance of this type typically is a rack-mounted device. The device includes physical security that enables the appliance to serve as a secure vault for sensitive information. Typically, the appliance is manufactured, pre-loaded with software, and then deployed within or in association with an enterprise or other network operating environment; alternatively, the box may be positioned locally and then provisioned with standard or customized middleware virtual images that can be securely deployed and managed, e.g., within a private or an on premise cloud computing environment. The appliance may include hardware and firmware cryptographic support, possibly to encrypt data on hard disk.

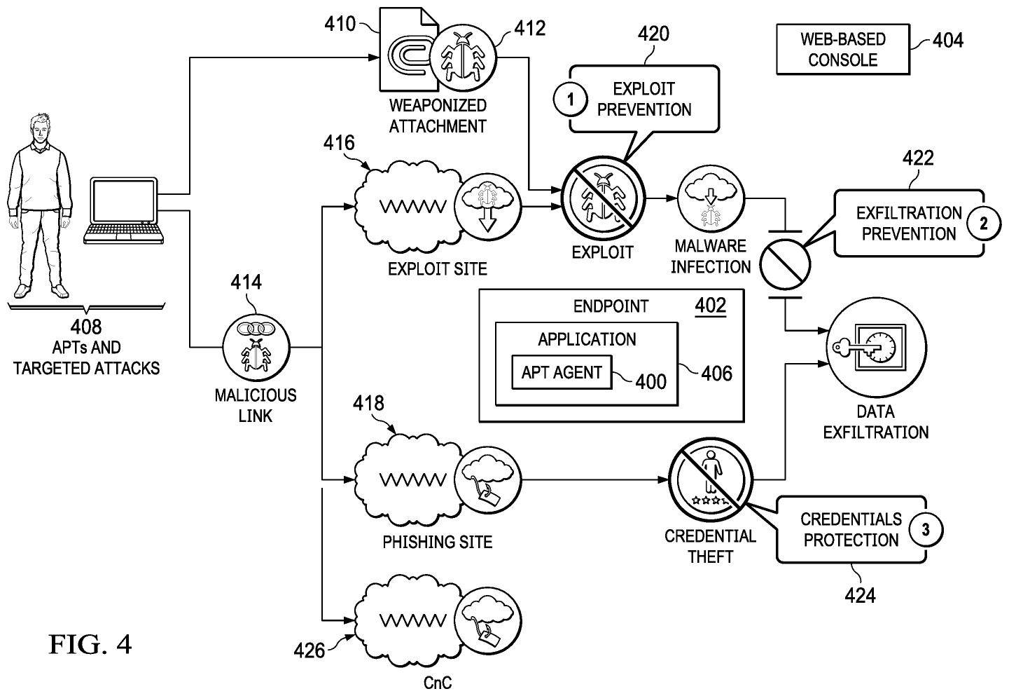

An appliance of this type can facilitate Security Information Event Management (STEM). For example, and as noted above, IBM® Security QRadar® STEM is an enterprise solution that includes packet data capture appliances that may be configured as appliances of this type. Such a device is operative, for example, to capture real-time Layer 4 network flow data from which Layer 7 application payloads may then be analyzed, e.g., using deep packet inspection and other technologies. It provides situational awareness and compliance support using a combination of flow-based network knowledge, security event correlation, and asset-based vulnerability assessment. In a basic QRadar STEM installation, the system such as shown in FIG. 4 is configured to collect event and flow data, and generate reports. A user (e.g., an SOC analyst) can then investigate offenses to determine the root cause of a network issue.

Generalizing, Security Information and Event Management (SIEM) tools provide a range of services for analyzing, managing, monitoring, and reporting on IT security events and vulnerabilities. Such services typically include collection of events regarding monitored accesses and unexpected occurrences across the data network, and analyzing them in a correlative context to determine their contribution to profiled higher-order security events. They may also include analysis of firewall configurations, network topology and connection visualization tools for viewing current and potential network traffic patterns, correlation of asset vulnerabilities with network configuration and traffic to identify active attack paths and high-risk assets, and support of policy compliance monitoring of network traffic, topology and vulnerability exposures. Some SIEM tools have the ability to build up a topology of managed network devices such as routers, firewalls, and switches based on a transformational analysis of device configurations processed through a common network information model. The result is a locational organization which can be used for simulations of security threats, operational analyses of firewall filters, and other applications. The primary device criteria, however, are entirely network- and network-configuration based. While there are a number of ways to launch a discovery capability for managed assets/systems, and while containment in the user interface is semi-automatically managed (that is, an approach through the user interface that allows for semi-automated, human-input-based placements with the topology, and its display and formatting, being data-driven based upon the discovery of both initial configurations and changes/deletions in the underlying network), nothing is provided in terms of placement analytics that produce fully-automated placement analyses and suggestions.

### Advanced Persistent Threat (APT) Prevention

APT mitigation and prevention technologies are well-known. For example, IBM® Trusteer Apex® is an automated solution that prevents exploits and malware from compromising enterprise endpoints and extracting information. A solution of this type typically provides several layers of security, namely, exploit prevention, data exfiltration prevention, and credentials protection.

FIG. 4 depicts a typical embodiment, wherein the APT solution is architected generally as agent code 400 executing in enterprise endpoint 402, together with a web-based console 404 that enables IT security to manage the deployment (of both managed and unmanaged endpoints) from a central control position. The agent code 400 operates by monitoring an application state at the time the application 406 executes sensitive operations, e.g., writing a file to the file system. Generally, the agent 400 uses a whitelist of legitimate application states to verify that the sensitive operation is executed (or not) under a known, legitimate state. An exploit will attempt to execute sensitive operations under an unknown (not whitelisted) state, thus it will be stopped. The approach enables the APT agent to accurately detect and block both known and zero-day exploits, without knowing anything about the threat or the exploited vulnerability. The “agent” may be any code-based module, program, process, component, thread or the like.

FIG. 4 depicts how APT attacks typically unfold and the points at which the APT solution is operative to stop the intrusion. For example, here the attacker 408 uses a spear-phishing email 410 to send an employee a weaponized document, one that contains hidden exploit code 412. When the user opens the document with a viewer, such as Adobe Acrobat or Word, the exploit code runs and attaches to an application vulnerability to silently download malware on the employee computer 402. The employee is never aware of this download. Another option is to send a user a link 414 to a malicious site. It can be a malicious website 416 that contains an exploit code or a legitimate website that was compromised (e.g., through a watering hole attack). When the employee clicks the link and the browser renders the HTML content, the exploit code runs and latches onto a browser (or browser plug-in) vulnerability to silently download malware on the employee computer. The link can also direct the user to a phishing site (like a fake web app login page) 418 to convince the user to submit corporate credentials. After infecting the computer 402 with advanced malware or compromising corporate credentials, attacker 408 has established a foothold within the corporate network and then can advance the attack.

As depicted, the agent 400 protects the enterprise against such threats at several junctions: (1) exploit prevention 420 that prevents exploiting attempts from compromising user computers; (2) exfiltration prevention 422 that prevents malware from communicating with the attacker and sending out information if the machine is already infected with malware; and (3) credentials protection 424 that prevent users from using corporate credentials on non-approved corporate sites (including phishing or and public sites like social networks or e-commerce, for example). In one known approach, the agent performs these and related operations by monitoring the application and its operations using a whitelist of legitimate application states.

By way of additional background, information-stealing malware can be directly installed on endpoints by the user without requiring an exploit. To exfiltrate data, typically the malware must communicate with the Internet directly or through a compromised application process. Advanced malware uses a few evasion techniques to bypass detection. For example, it compromises another legitimate application process and might communicate with the attacker over legitimate websites (like Forums and Google Docs). The agent 400 is also operative to stop the execution of untrusted code that exhibits data exfiltration states. To this end, preferably it validates that only trusted programs are allowed to use data exfiltration techniques to communicate with external networks. The agent preferably uses several techniques to identify unauthorized exfiltration states and malicious communication channels, and blocks them. Because it monitors the activity on the host itself, it has good visibility and can accurately detect and block these exfiltration states.

The reference herein to the identified commercial product is not intended to be limiting, as the approach herein may be implemented with any APT solution or functionality (even if embedded in other systems).

### Cognitive Cybersecurity Analytics

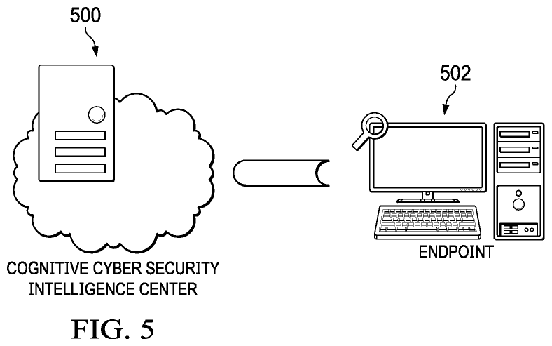

FIG. 5 depicts a basic operating environment that includes a cognitive cybersecurity intelligence center 500, and an endpoint 502. An endpoint 502 is a networked device that runs systems management code (software) that enables management and monitoring of the endpoint by the intelligence center 500.

The endpoint typically is a data processing system, such as described above in FIG. 2. The intelligence center 500 may be implemented as a security management platform such as depicted in FIG. 3, in association with an APT solution such as depicted in FIG. 4, or in other management solutions. Thus, for example, known commercial products and systems that provide endpoint management include IBM® BigFix®, which provides system administrators with remote control, patch management, software distribution, operating system deployment, network access protection and hardware and software inventory functionality. A commercial system of this type may be augmented to include the endpoint inter-process activity extraction and pattern matching techniques of this disclosure, or such techniques may be implemented in a product or system dedicated for this purpose.

In a typical implementation, an endpoint is a physical or virtual machine or device running an operating system such as Windows, Mac OSX, Vmware ESX, Linux, Unix, as various mobile operating systems such as Windows Phone, Symbian, iOS and Android. The cybersecurity intelligence center typically operates as a network-accessible security management platform comprising a plurality of machines and application software. Typically, the intelligence center supports cybersecurity analytics, e.g., using machine learning and the like. The intelligence center may operate in a dedicated manner to support a plurality of endpoints, or “as-a-service” on behalf of multiple enterprises each having their own endpoints. Typically, endpoint machines communicate with the intelligence center in a client-server paradigm, such as depicted in FIG. 1 and described above. The intelligence center may be located and accessed in a cloud-based operating environment.

In this approach, events, such as inter-process, events are sent from endpoints, such as endpoint 502, to a detection server executing in the intelligence center 500, where such events are analyzed. Preferably, attack detection occurs in the detection server. This approach provides for an efficient, systematic (as opposed to merely ad hoc) mechanism to record endpoint activities, e.g., via inter-process events, to describe a malicious or suspicious behavior of interest with abstractions (network graphs), and to match concrete activities (as represented in the recorded events) with abstract patterns. This matching enables the system to act upon malicious/suspicious behaviors (e.g., by halting involved processes, alerting, dropping on-going network sessions, halting on-going disk operations, and the like), as well as to assist security analysts to locate interesting activities (e.g., threat hunting) or to determine a next step that may be implemented in a workflow to address the suspect or malicious activity.

### Automatic Semantic Modeling of System Events

With the above as background, the system event modeling technique of this disclosure and its use for behavior-based anomaly detection are now described.

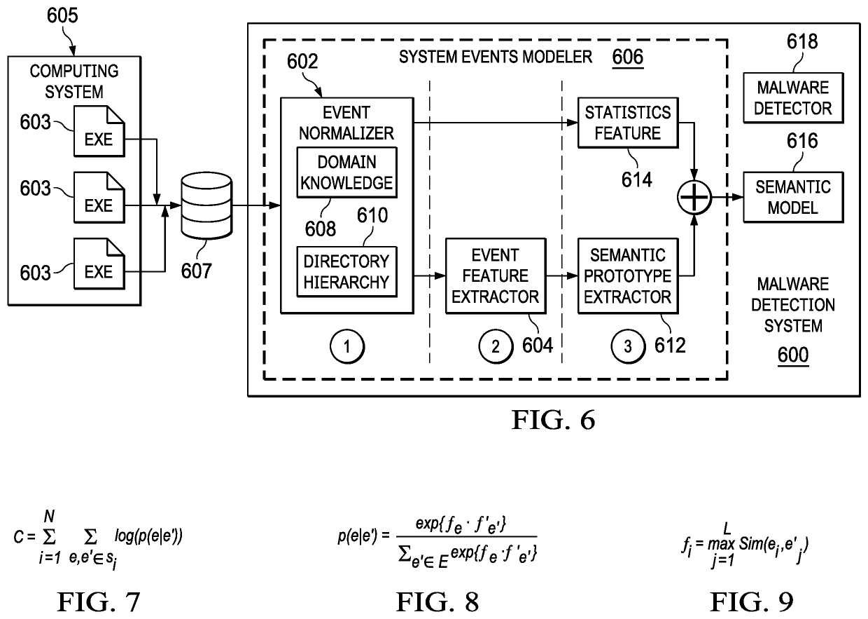

A behavior-based malware detection system 600 in which the technique of this disclosure. is practiced with respect to a monitored computing system 601 is depicted in FIG. 6. The computing system 605 being monitored may be implemented as described above with respect to FIG. 2, and it is assumed to comprise executing a set of (runtime) processes 603. System events, e.g., system calls and API calls of each process 603, are continuously monitored and recorded, e.g., in a data store 607. The particular manner in which the system events are monitored, identified and stored is not an aspect of this disclosure. In a typical implementation, system activities of this type are logged, e.g., by the operating system, or by via syscall monitoring and program instrumentation. The malware detection system 600 of this disclosure is configured to execute in any of the operating system environments described above, e.g., FIG. 3, FIG. 4 or FIG. 5. One of more components of the malware detection system 600 may execute in a cloud-based architecture. In a variant implementation, the malware detection system executes natively in the computing system whose system events are being monitored.

As also shown in FIG. 6, a representative processing pipeline of the system events modeler of this disclosure comprises the three (3) depicted modules, namely: (1) event normalizer 602, (2) event feature extractor 604 and (3) process encoder 606. Typically, each such module is implemented in software, namely, as a set of computer program instructions, executed in one or more hardware processors. These modules may be integrated with one another, co-located or distributed, or otherwise implemented in one or more computing entities. One or more of these functions may be implemented in the cloud.

In operation, the event normalizer 602 scans the raw system events collected in data store 607 (e.g., a database storing a system event log). As its name implies, the event normalizer 602 normalizes the event name, e.g., using domain knowledge 608, and statistical methods such as directory hierarchy 610. This operation is advantageous, as it reduces the number of unique system events that then need to be processed by the remaining modules. In operation, the event normalizer greatly reduces the number of these singleton events, thereby providing computational and storage efficiencies. As will be described in more detail below, the event feature extractor 604 extracts one or more features of system events preferably using an event co-occurrence strategy, and by performing context-based event modeling. The process encoder 616 projects a process 603 (which consists of multiple system events) to a feature vector space. The output of the system event modeler is a semantic system event model 616. As depicted, the model is then consumed by the malware detector 618, which operates to provide behavior-based malware detection.

Each of the above-described modules of the system event modeler is now described in further detail.

As has been described, a basic goal of the event normalizer process 602 is to reduce event variation. The normalizer 602 processes the raw system events via the domain knowledge 608 and statistical analysis 610 to reduce the system event dataset. Preferably, both domain knowledge and statistical analysis are used by the module, although this is not a requirement. This operation is seen in the following example, which utilizes system event samples from Windows OS. This is just a representative use case, and it is not intended to be limiting. In Windows, a file or registry can have multiple different names, and this is a scenario where applying domain knowledge 608 is useful to address inconsistences of event names. In this example, assume that the domain knowledge 608 provides for the following detailed rules of event name normalization: (1) identify SID, GUID and hash, and replace it with its type, for example, <SID> and <MD5>; (2) replace the full directory with its corresponding system environment variable; (3) identify universal naming convention, e.g., rename \\!\C:\windows\system32\ to C:\windows\system32; (4) replace HKEY_CLASSES_ROOT with HKEY_LOCAL_MACHINE\Software\Classes; and (5) remove the path from URL, and only keep the fully-qualified domain name (FQDN) for the remote server. In addition to applying domain knowledge 608, the event normalizer (in this example) applies one or more statistical methods 610 to reduce the variation of event name. Thus, for example, here the event normalizer process 602 counts the occurrence of event name (i.e. file name and registry key), as well as all the ancestors in the directory hierarchy. The process then sets a threshold for the minimum occurrence (or that threshold is preconfigured), and the process then replaces the singleton event with its closest ancestor that satisfies the requirement. As noted, these are merely representative operations of the event normalizer for the Window OS system events use case. For example, by using domain knowledge 608, it is known that \\!\:\windows\system32\ is equivalent to C:\windows\system32\ in the Windows operating system. Using a statistical approach 610, for example, the system would remove application name from the registry hkey_current_user\software\microsoft\windows\currentversion\run.

Generalizing, the domain knowledge and statistical methods applied by the event normalizer process typically are implementation-specific, with the overarching goal of reducing the raw system event dataset into a manageable size for the subsequent processing.

The event feature extractor module 604 extracts one or more features of system events (having been normalized by the event normalizer 602), preferably through event co-occurrence, wherein the semantics are inferred from specific co-occurrences of events in training. Thus, an example, a semantic of a configuration file may be expressed as follows: vector (“vim”)−vector (“vimrc”)+vector (“bash”)=vector (“bashrc”); another example, a semantic of a receive-n-save procedure may be expressed by the following: vector (“nginx receiving data from an IP”)−vector (“nginx writing to a file”)+vector (“sendmail receiving data from an IP”)=vector (“sendmail writing to a file”)). Of course, these are just representative examples.

The feature extractor is configured to project the events to a vector space, and then to apply context-based event modeling. Preferably, and as will be described, the context-based event modeling derives from a skip-gram model in word2vec, and it is based on the insight that events are related if they appear in a same observation sample. The feature extractor preferably also implements an objective probability error function, as will be described.

In particular, assume that there are N samples S={s₁, s₂, . . . , s_{N}}, and that each sample contains a set of system events s={e}, e∈E, where E is the set of total system events. A cost function C then is defined as shown in FIG. 7, namely, as the sum of log likelihood of target system event e given its context event e′. In this equation, the probability e|e′ is determined by the feature of events. Now, let fₑ be the feature of event e, and let f′ₑ be an auxiliary weight of event e. The probability then is modeled as shown in FIG. 8, where fₑ·fₑ′ is an inner product of fₑ and fₑ′. The feature and auxiliary weight preferably are trained, e.g., using gradient descent.

As noted above, preferably the event feature extractor module extracts features of system events. According to a preferred approach herein, this model is derived from the skip-gram model, which was first proposed by Mikolov et al. in natural language processing. As is known, natural language processing (NLP) is the parsing and semantic interpretation of text, which allows systems to learn, analyze, and understand human language. Text representation plays an important role in many natural language processing (NLP) tasks, such as document classification and clustering, sense disambiguation, machine translation, and document matching. In the Mikolov approach, distributional or contextual information together with simple neural network models are used to obtain vector-space representations of words and phrases. One of these is word2Vec, which refers to a class of models that represents a word in a large text corpus as a vector in n-dimensional space (or n-dimensional feature space) bringing similar words closer to each other. One particular model is the skip-gram model. The skip-gram model tries to predict source context words (surrounding words) given a target word (the center word). In that model, a context word is determined by a sliding window.

According to this disclosure, and as is explained below, this notion is extended to automatically extract the features of systems events. In particular, in the model described herein, preferably all other events in the same observation sample are considered to be the “context” of the target event. Then, the described technique preferably enumerates all the possible pairs in each observation sample, thereby providing the relevant “context” or semantic meaning. In the equation shown in FIG. 8, the auxiliary weight f′ is used because the algorithm simulates the neural network model, and the auxiliary weight corresponds to the weight in an output layer of the neural network.

The process encoder module 606 operates to project the process, which consists of multiple system events, to the feature vector space. To this end, the process encoder module 606 defines one or more semantic prototypes as representative events that covers all the other events in the feature space within a distance threshold dₜ. Typically, there are several solutions for finding the semantic prototypes. A first solution, depicted as semantic prototype extractor 612, proceeds as follows. During each iteration, the encoder randomly picks one event eₚ as prototype and removes all the events e′ if the distance between e and e′ is less than dₜ. If there are events left, the routine goes back and picks another prototype event, and the process iterates until complete. A second solution, which is depicted as statistics feature 616, instead uses hierarchical clustering to determine the semantic prototype, and that clustering algorithm is stopped when the distance between clusters are greater than dₜ. The former approach efficiently identifies the prototype that preserves the spatial structure of the feature space, while the latter approach focuses on finding optimal and accurate semantic prototypes. By identifying the semantic prototype(s), the process encoder 606 removes redundant events but still preserves the spatial relationship of the event feature space.

After removing redundant events, the process encoder then determines the feature of the observable sample, preferably by measuring the similarity between the semantic prototypes and system events of the process. Formally, assume there are M semantic prototypes Ep={e₁, e₂, . . . , e_{M}}, and that the target sample has L events Eₛ={e′₁, e′₂, . . . , e′_{L}}. Let Sim (e, e′) be the cosine similarity between events e and e′. Then the i^{th} element of sample feature f^{f} is then calculated as shown in FIG. 9. Preferably, the process encoder uses statistical metrics as the coarse-grained feature f^{c}. Additionally, the process encoder calculates the percentage of events for each operation, as well as the percentage of uncommon events that are not present in the training set. This feature is useful to capture the program that has unknown behaviors. To complete the processing, the feature of the program is then computed as the concatenation of both fine-grained feature f^{f} and coarse-grained feature f^{c}.

Referring back to FIG. 6, the automatic generation of the system events semantic model 616 is carried out synchronously or asynchronously, on-demand or in response to an occurrence, and that semantic model typically is updated periodically, continuously, or upon a given occurrence. As previously described, the system event semantic model 616 is then used in a behavior-based malware detector 618 to provide go-forward malware detection for the computing system.

The system event semantic model may be used to facilitate malware detection for computing systems other than the computing system(s) whose system events were recorded and used to facilitate the model building.

The system events modeling technique of this disclosure—which automatically extracts features for system events—has significant advantages. Foremost, the technique captures the semantic relationship between and among these events. The training is automatic, and it requires little domain knowledge. In particular, and as described above, the semantic relations among embedded event(s) are learned automatically; that said, to make the learning more effective, preferably there is a pre-processing step (namely, the event normalizer) before the raw data is supplied to the training phase of the model. The required domain knowledge is just that needed to implement the normalization function.

In addition, the training algorithm is computationally-efficient, especially in the context of large datasets (Big data), and it is suitable for processing even large sparse datasets. As previously described, the technique of this disclosure exploits the notion that a feature of events should be close in vector space if they frequently appear in the same observable sample. If the two events are likely to occur in a same scenario (e.g., checking a network connection, kill anti-virus service, etc.), they are close in the feature space. As noted, the model is able to reconstruct the probability of co-occurrence between and among system events, where that probability is determined by the feature of the system events. Due to this assumption, the feature captures the semantic relationship among system events and group events that likely appear in the same scenario. Principal component analysis (PCA), an alternative approach to finding the semantic relationship, does not satisfy these requirements because of computational complexity and human intuition. PCA is computationally-expensive especially when both the number of observations and feature dimension are large. If one considers the system events as a binary feature, then the feature vector is highly-sparse, and therefore PCA does not have a good performance. Moreover, the result from PCA is not intuitive for human analysts. The new feature vector after dimension reduction is the linear combination of original features, which lacks semantic meaning and is not easily interpreted by a human.

The technique for system events modeling is implemented to automatically extract one or more features that may then be used to classify and detect malware. As has been described, the approach herein involves building a semantic model, which is a type of information model that supports the modeling of entities—in this case, system events, and their relationships. The model described captures semantic relationship among events. Further, training of the model is automatic, requires little domain knowledge, and the approach (which preferably includes the pre-processing prior to training) is efficient.

As also noted, the technique herein preferably applies a methodology analogous to the skip-gram model in word2vec in natural language processing. In that model, a context word is determined by a sliding window. The event modeler here deals in events, not words. In the model described herein, all the other events in the same observable sample are considered to be the context of the target event. Then, the described technique preferably enumerates all the possible pairs in each observation sample. Although this approach increases the training set in theory, the sparsity of events guarantees that the actual number of pair-wise enumerations does not impact computationally efficiency.

As noted, an important assumption of the described technique is that the feature of events should be close in a vector space if they frequently appear in the same sample. Once trained in the manner described above, the model is able to reconstruct a probability of co-occurrence between or among system events, where the probability is determined by the feature of the system events. Due to this assumption, the feature captures the semantic relationship(s) among system events and group events that likely appear in the same scenario. As also noted, the technique preferably leverages a neural network-derived construct known as a skip-gram, wherein other events in the same sample are considered to be the context of the target event. To build the model, all the possible pairs in each observation sample are enumerated. In the model, and given a sample that includes a set of system events and a target system event, other events in the sample are considered to be the “context” of the target event, and all possible system event pairs are enumerated.

As has also been described, before training the model, preferably both domain knowledge and statistics-based techniques are applied to reduce the number of singleton events.

The technique herein enables machines to automatically understand machine events associated with semantics. The approach preferably utilizes high-dimensional vector processing, which is more comprehensive and processes large number of events efficiently even for a sparse dataset.

The approach herein is designed to be implemented in an automated manner within or in association with a security system, such as a SEIM device or system in FIG. 3, an APT platform as depicted in FIG. 4, a cloud-based cybersecurity analytics system in FIG. 5, or some other execution environment wherein system events are captured and available for mining and examination. The system event modeler (or any component thereof) as described may reside in any of these devices, systems or platforms. The particular operating platform or computing environment in which the event modeler technique is implemented, however, is not a limitation. The machine learning itself can be provided “as-a-service” using a machine learning platform or service.

Alternatively, the functionality described above may be implemented as a standalone approach, e.g., a software-based function executed by a processor, or it may be available as a managed service (including as a web service via a SOAP/XML interface). The particular hardware and software implementation details described herein are merely for illustrative purposes are not meant to limit the scope of the described subject matter.

More generally, computing devices within the context of the disclosed subject matter are each a data processing system (such as shown in FIG. 2) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

The scheme described herein may be implemented in or in conjunction with various server-side architectures including simple n-tier architectures, web portals, federated systems, and the like. The techniques herein may be practiced in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the identity context-based access control functionality can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

The computer program product may be a product having program instructions (or program code) to implement one or more of the described functions. Those instructions or code may be stored in a computer readable storage medium in a data processing system after being downloaded over a network from a remote data processing system. Or, those instructions or code may be stored in a computer readable storage medium in a server data processing system and adapted to be downloaded over a network to a remote data processing system for use in a computer readable storage medium within the remote system.

In a representative embodiment, the machine learning-based techniques are implemented in a special purpose computer, preferably in software executed by one or more processors. The software is maintained in one or more data stores or memories associated with the one or more processors, and the software may be implemented as one or more computer programs. Collectively, this special-purpose hardware and software comprises the functionality described above.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

The techniques herein provide for improvements to another technology or technical field, among others: malware detectors, endpoint management systems, APT solutions, security incident and event management (SIEM) systems, as well as cybersecurity analytics solutions.

The system event modeler techniques herein may be used to discover and act upon activity in other than an enterprise endpoint machine. Further, as a skilled person will appreciate, the semantic model as described herein turns event(s) at runtime into a vector space, all while preserving the semantic relationship among them. The provides a significant advantage in that a human being does not need to specify any semantic relation explicitly, thereby reducing dependency on domain knowledge This approach herein generally is applicable to help system administrators, security analysts, software developers and others to better understand the behaviors of software of interest. Thus, for example, software developers (after providing model results into an analyzer) may use the approach herein to find software bugs or undefined functionalities. System administrators can use the approach to reveal behaviors that are not consistent with specified policies or defined usages. Security analysts can use the approach to detect malware, attacks, advanced persistent threats (APTs), or the like. In summary, the model and methodology described provides for a core encoding/embedding functionality that can be used by multiple applications and use cases.

Having described the subject matter above, what we claim is as follows:

1. A method to detect anomalous behavior in an execution environment, comprising:
receiving a set of system events captured from a monitored computing system;
training a model to automatically extract one or more features for the received set of system events, wherein a system event feature represents a semantic relationship between or among a grouping of system events that are observed to co-occur in an observation sample; and
detecting anomalous behavior using the model.

2. The method as described in claim 1 further including processing the set of system events into a reduced set of system events prior to the training.

3. The method as described in claim 2 wherein the processing includes one of: applying domain knowledge, and applying one or more statistical methods.

4. The method as described in claim 1 wherein training the model utilizes a semantic analysis that determines co-occurrence for a target system event in the observation sample by pairwise enumeration of the target system event with respect to each other system event in the observation sample.

5. The method as described in claim 1 wherein the system event feature is determined by measuring a similarity of the set of system events with respect to one or more semantic prototypes defined as representative events for the observation sample.

6. The method as described in claim 5 wherein the semantic prototypes represent a feature space.

7. The method as described in claim 1 wherein the observable sample is associated with an operating scenario in the execution environment.

8. An apparatus, comprising:
a processor;
computer memory holding computer program instructions executed by the processor, the computer program instructions configured to detect anomalous behavior in an execution environment, the computer program instructions comprising:
program code configured to receive a set of system events captured from a monitored computing system;
program code to train a model to automatically extract one or more features for the received set of system events, wherein a system event feature represents a semantic relationship between or among a grouping of system events that are observed to co-occur in an observation sample; and
program code to detect anomalous behavior using the model.

9. The apparatus as described in claim 8 further including program code configured to process the set of system events into a reduced set of system events prior to the training.

10. The apparatus as described in claim 9 wherein the program code configured to process includes program code configured to apply domain knowledge, or to apply one or more statistical methods.

11. The apparatus as described in claim 8 wherein the program code configured to train the model utilizes a semantic analysis that determines co-occurrence for a target system event in the observation sample by pairwise enumeration of the target system event with respect to each other system event in the observation sample.

12. The apparatus as described in claim 8 wherein the system event feature is determined by program code configured to measure a similarity of the set of system events with respect to one or more semantic prototypes defined as representative events for the observation sample.

13. The apparatus as described in claim 12 wherein the semantic prototypes represent a feature space.

14. The apparatus as described in claim 8 wherein the observable sample is associated with an operating scenario in the execution environment.

15. A computer program product in a non-transitory computer readable medium for use in a data processing system, the computer program product holding computer program instructions that, when executed by the data processing system, are configured to detect anomalous behavior in an execution environment, the computer program instructions comprising:
program code configured to receive a set of system events captured from a monitored computing system;
program code to train a model to automatically extract one or more features for the received set of system events, wherein a system event feature is determined by a semantic relationship between or among a grouping of system events that are observed to co-occur in an observation sample; and
program code to detect anomalous behavior using the model.

16. The computer program product as described in claim 15 further including program code configured to process the set of system events into a reduced set of system events prior to the training.

17. The computer program product as described in claim 16 wherein the program code configured to process includes program code configured to apply domain knowledge, or to apply one or more statistical methods.

18. The computer program product as described in claim 15 wherein the program code configured to train the model utilizes a semantic analysis that determines co-occurrence for a target system event in the observation sample by pairwise enumeration of the target system event with respect to each other system event in the observation sample.

19. The computer program product as described in claim 15 wherein the system event feature is determined by program code configured to measure a similarity of the set of system events with respect to one or more semantic prototypes defined as representative events for the observation sample.

20. The computer program product as described in claim 19 wherein the semantic prototypes represent a feature space.

21. The computer program product as described in claim 15 wherein the observable sample is associated with an operating scenario in the execution environment.
